(19) United States
(12) Patent Application Publication
(10) Pub. No.: US 2025/0389861 A1
(43) Pub. Date: Dec. 25, 2025

(54) SEISMIC INVERSION METHOD BASED ON JOINT CONSTRAINT OF PHYSICAL MODEL AND PRIORI INFORMATION

(71) Applicant: Southwest Jiaotong University, Chengdu (CN)

(72) Inventors: Jian Zhang, Chengdu (CN); Xiaoyan Zhao, Chengdu (CN); Yiran Xue, Chengdu (CN); Hui Sun, Chengdu (CN)

(21) Appl. No.: 19/215,387

(22) Filed: May 22, 2025

Related U.S. Application Data
(63) Continuation of application No. PCT/CN2025/094792, filed on May 14, 2025.

(30) Foreign Application Priority Data
Jun. 20, 2024 (CN) 202410796927.4

(51) Int. Cl. G01V 1/30; G01V 1/28; G06F 17/17

(52) U.S. Cl. CPC G01V 1/307; G01V 1/282; G06F 17/17; G01V 2210/63

(57) ABSTRACT

The present disclosure discloses a seismic inversion method based on joint constraint of a physical model and priori information. The method includes: extracting seismic wavelets based on seismic data, and determining an amplitude scaling factor of the wavelets; counting priori information of impedance parameters; establishing an initial impedance parameter model by using seismic structural interpretation information and logging data; obtaining a simplified approximate equation based on an interface weak elasticity difference hypothesis, forward modeling a seismic gather by using the simplified equation, and calculating an inversion residual; rewriting an objective function into a function related to the impedance parameters by using a generalized linear inversion idea, solving the impedance parameters by using an iterative reweighted least squares algorithm, and updating the impedance parameters; and repeating the above steps until the inversion residual reaches the requirements or reaches the maximum number of iterations, and outputting a final processing result.

### CROSS REFERENCE TO RELATED APPLICATIONS

The present application is a Continuation Application of PCT Application No. PCT/CN2025/094792 filed on May 14, 2025, which claims the benefit of Chinese Patent Application No. 202410796927.4 filed on Jun. 20, 2024. All the above are hereby incorporated by reference in their entirety.

### TECHNICAL FIELD

The present disclosure relates to the technical field of seismic exploration, and in particular, to a seismic inversion method based on joint constraint of a physical model and priori information.

### BACKGROUND

Seismic exploration is a method of inferring underground geological structures by artificially stimulating seismic waves and recording their propagation characteristics underground. The propagation speed, reflection, and transmission characteristics of seismic waves in different media carry rich geological information, and seismic impedance is one of the key parameters to describe such information. Seismic impedance, defined as the product of the density of a rock and its longitudinal wave velocity, directly reflects the physical properties of the rock, such as porosity, saturation, and rock type. These properties are crucial for identifying oil and gas reservoirs and other economic minerals. As global energy demand continues to grow, finding and developing new oil and gas resources is becoming increasingly urgent. The depletion of traditional oil and gas fields and the scarcity of new resources require that exploration technology must be more efficient and precise. Seismic impedance inversion can provide high-resolution underground images to help geologists accurately identify the boundaries, fluid properties, reservoir quality, and hydrocarbon content of oil and gas reservoirs, thereby improving the success rate of exploration and reducing drilling risks and costs. The core goal of wave impedance inversion is to convert seismic data into parameters that can directly reflect the physical properties of rocks. This step is indispensable for reservoir prediction and oil reservoir description. Wave impedance, as a comprehensive parameter, can bridge the gap between the physical propagation characteristics of seismic waves and the actual geological properties of rocks. Through wave impedance inversion, geologists can indirectly estimate reservoir parameters such as porosity and permeability of the formation, which is crucial for evaluating reservoir productivity and formulating development strategies. With the deepening of research, various wave impedance inversion methods have emerged, including but not limited to trace integral inversion, generalized linear inversion, iterative inversion, nonlinear inversion, etc. Each method has its advantages and limitations. For example, the trace integral inversion is simple and direct but has limited accuracy, while the generalized linear inversion has higher accuracy but is easily affected by high-frequency noise. Model-based inversion technology breaks through the limitations of traditional seismic resolution, and can theoretically achieve the same resolution as logging information. However, the high- and low-frequency components provided by the logging information and the model in inversion results lead to multi-solution of the inversion and are restricted by the number of wells drilled and the distribution of the well network. In order to reduce the multi-solution of inversion, some priori information is usually introduced in the inversion process. However, the existing method for imposing constraints on priori information (such as initial model) is to directly calculate an error between inversion results, resulting in reduced accuracy of the inversion results.

In summary, the current research on seismic impedance inversion methods has the following problems: 1. Due to the influence of seismic wavelet band limit, the trace integral seismic impedance inversion is low in the resolution of inversion results and is greatly affected by the initial impedance value, resulting in a large cumulative error; 2. The method for first inverting the reflection coefficient and then recursively calculating the impedance is greatly affected by seismic data noise, resulting in a large cumulative error; 3. In order to reduce the multi-solution of inversion results, the existing model-based seismic impedance inversion method introduces priori constraint information such as an initial model, which, however, reduces the resolution of inversion results by directly using this as a constraint; 4. The deterministic seismic impedance inversion method can give only a unique inversion result, and the reliability of the result cannot be evaluated, resulting in the increase of the risk of subsequent interpretation.

### SUMMARY

The purpose of the present disclosure is to overcome the shortcomings in the prior art, and a seismic inversion method based on joint constraint of a physical model and priori information is provided. A model-based inversion strategy is adopted, a physical model is introduced to ensure that the prediction result meets the observed seismic data, an initial model priori information constraint term is designed to calculate an error between the low frequency of inversion results and the initial model priori to improve the resolution of inversion results while reducing the multi-solution of inversion results, and the uncertainty of inversion results is given while predicting inversion results based on a Bayesian framework, meeting the requirements of high-precision seismic exploration and fine oil reservoir characterization.

The purpose of the present disclosure is achieved by the following technical solution: A seismic inversion method based on joint constraint of a physical model and priori information, including the following steps:
step 110: extracting wavelets by using actual seismic data, forward modeling a seismic gather based on logging data and a post-stack seismic reflection coefficient equation, and determining an amplitude scaling factor in combination with actual well-side seismic data;
step 120: extracting impedance parameters and a mean value thereof based on all logging data in a work area, and statistically calculating a variance and a vertical variation function matrix of the impedance parameters;
step 130: establishing an initial impedance parameter model in a time domain by using seismic data layer interpretation information and the logging data;
step 140: deriving a linear approximate equation based on an interface weak elasticity difference hypothesis from an accurate post-stack reflection coefficient equation, forward modeling the post-stack seismic gather based on the initial impedance parameter model in the time domain and a simplified equation, and directly calculating an inversion residual from a forward modeling record and an actual record;
step 150: constructing an inversion objective function in the sense of maximum a posteriori probability based on the Bayesian principle, as well as the introduction of a sparse priori constraint term and an initial model priori information constraint term, and solving the inversion objective function by using a generalized linear inversion idea to obtain a solution expression for the impedance parameters;
step 160: calculating model parameters by using an iterative reweighted least squares algorithm according to the formula of a solution expression of the model parameters and the inversion residual; and
step 170: repeating the iterations of the above steps 140, 150, and 160, and controlling the maximum number of iterations by means of the inversion residual to obtain an optimal impedance parameter inversion result.

Specifically, in step 110, a reflection coefficient is calculated by using the post-stack seismic reflection coefficient equation and taking the logging data as an input model:

$${r}_{i} = f ( m ) = \frac{{m}_{i + 1} - {m}_{i}}{{m}_{i + 1} + {m}_{i}} \qquad ( 1 )$$

in the formula, m represents logging impedance parameter data, and r represents the calculated reflection coefficient;
the reflection coefficient is then convolved with the extracted seismic wavelets to obtain a seismic gather which is compared with an actual well-side seismic gather, and the amplitude scaling factor is calculated and applied to the extracted seismic wavelets to achieve amplitude matching between a modeling record and an actual record:

$$x = w ⊗ r \qquad ( 2 )$$

in the formula, x represents a synthetic seismic record, ⊕ represents a convolution operator, and w represents the extracted wavelets.

Specifically, in step 120, the required impedance parameters are obtained by analyzing the logging data, an autocorrelation coefficient of the impedance parameters is obtained, a variance matrix is constructed, and vertical variation functions are calculated based on the impedance parameters to form impedance parameter priori distribution functions that conform to the work area;
the calculation formula of the vertical variation functions is as follows:

$$υ ( h ) = \frac{1}{2 N} {\sum }_{i = 1}^{N} {[ z ( {x}_{i} ) - z ( {x}_{i} + h ) ]}^{2} \qquad ( 3 )$$

where ν represents a variation function value calculated based on well data, h represents a hysteresis distance, N represents the length of the logging data, and z(xᵢ) represents the impedance parameter value at a location i.

Specifically, in step 130, a geological model is established based on a sedimentary pattern by using seismic structural interpretation information, and logging information is interpolated and extrapolated according to a structural pattern to obtain the initial impedance parameter model of each survey line; an impedance parameter model is established by using a spatial interpolation method, in which the data of each layer is interpolated first by using a scattered interpolation method to complete geological layer modeling, and then lateral interpolation of the impedance parameters is carried out according to geological layers to calculate the impedance parameter value at each point underground, so as to complete the task of initial impedance parameter modeling.

Specifically, in step 140, the linear approximate equation is derived based on the weak elasticity difference hypothesis:

$${r}_{i} = f ( m ) = \frac{{m}_{i + 1} - {m}_{i}}{{m}_{i + 1} + {m}_{i}} \approx 0.5 \times ( ln ( {m}_{i + 1} ) - ln ( {m}_{i} ) ) \qquad ( 4 )$$

in the formula, m represents the impedance parameter data, r represents the calculated reflection coefficient, and In represents the logarithm of the data;
the initial impedance parameter model in the time domain is then taken as input, a reflection coefficient vector is directly calculated by using the simplified equation, the seismic wavelets are convolved with the reflection coefficient to obtain the post-stack seismic gather, and the post-stack seismic gather is subtracted from an actual seismic gather to obtain the inversion residual:

$$x = w ⊗ r = 0.5 \cdot K \cdot D \cdot ln ( m ) \qquad ( 5 )$$

in the formula, K represents a wavelet matrix constructed based on w, D represents a difference operator, and m represents the impedance parameter data.

Specifically, in step 150, the inversion result is constrained by using the initial model, and it is assumed that seismic data noise obeys Gaussian distribution; the initial model priori information constraint term obeys the Gaussian distribution and the model obeys sparse distribution, then an inversion likelihood function and priori probability distribution satisfy the Gaussian distribution and the joint distribution of Gaussian and sparse, respectively; the inversion likelihood function and the priori distribution function are integrated according to the Bayesian principle to obtain a posteriori probability distribution function, the inversion objective function is determined according to the posteriori probability, and the objective function is derived from the model parameters to obtain an iterative solution formula:

Assuming that the impedance model parameters are z^{T}=(z₁, z₂, . . . , zₙ)^{T} and the observed seismic data are x^{T}=(x₁, x₂, . . . , xₙ)^{T}, it can be learned from the Bayesian theory that, in a case where the post-stack seismic data are known, the problem of inverting impedance parameters of an underground medium can be reduced to solving a posteriori probability function:

$$P ( z \vert x ) = \frac{P ( x \vert z ) P ( z )}{P ( x )} \qquad ( 6 )$$

where P(x)=∫p(x|z)p(z)dz is a normalization factor that can be regarded as a constant, P(x|z) is a likelihood function, and P(z) is the priori probability distribution; it is assumed that the likelihood function satisfies the Gaussian distribution:

$$P ( x \vert z ) = {( {( 2 π )}^{{N}_{x}} \vert {C}_{x} \vert )}^{- 1 / 2} exp ( - \frac{1}{2} {( x - Γ ( z ) )}^{T} {C}_{x}^{- 1} ( x - Γ ( z ) ) ) \qquad ( 7 )$$

in the above formula, Γ is a forward operator, C_{X} is a noise covariance matrix, and Nₓ is the length of the observed data; a normalization constant is removed based on the Bayesian theory in combination with a priori model, and the posteriori probability distribution of post-stack seismic data inversion can be expressed as:

$$P ( z \vert x ) ∝ P ( x \vert z ) P ( z ) ∝ exp ( - \frac{1}{2} {( x - Γ ( z ) )}^{T} {C}_{X}^{- 1} ( x - Γ ( z ) ) ) * exp ( - \frac{1}{2} {( {z}_{0} - φ z )}^{T} {C}_{z}^{- 1} ( {z}_{0} - φ z ) ) * exp ( - Φ ( z ) ) \qquad ( 8 )$$

in the expression, Γ is the forward operator, Φ(z) represents the sparse constraint term, z₀ represents the initial impedance parameter, φ represents a smoothing operator, C_{X} is the noise covariance matrix, C_{z} represents a model covariance matrix that can be obtained by Kronecker product of the variance α counted by the logging data and the variation function matrix ν, and the specific expressions of Φ(z) and φ are as follows:

$$Φ ( z ) = {‖ Dz ‖}_{0} \qquad ( 9 )$$

in the expression, D represents the difference operator; if three-point smoothing is used, the expression of φ can be written as:

$$φ = {[ \begin{matrix}1 / 3 & 1 / 3 & 1 / 3 & & & & & & & \\ & 1 / 3 & 1 / 3 & 1 / 3 & & & & & & \\ & & 1 / 3 & 1 / 3 & 1 / 3 & & & & & \\ & & & & & ⋱ & & & & \\ & & & & & & ⋱ & & & \\ & & & & & 1 / 3 & 1 / 3 & 1 / 3 & & \\ & & & & & & 1 / 3 & 1 / 3 & 1 / 3 & \\ & & & & & & & 1 / 3 & 1 / 3 & 1 / 3\end{matrix} ]}_{n \times n} \qquad ( 10 )$$

The expression of φ can be modified according to expression (10) according to different specific smoothing levels.

The optimal solution can be obtained by solving the maximum value of expression (8), which is equivalent to solving the solution corresponding to the minimum value of the objective function of the following formula:

$$J = \frac{1}{2} {( x - Γ ( z ) )}^{T} {C}_{X}^{- 1} ( x - Γ ( z ) ) + \frac{1}{2} {( {z}_{0} - φ z )}^{T} {C}_{z}^{- 1} ( {z}_{0} - φ z ) + {‖ Dz ‖}_{0} \qquad ( 11 )$$

The objective function obtained above is derived with respect to the impedance parameter z and the derivative is set equal to zero. Since the 0 norm is not derivable, the iterative reweighted least squares algorithm is used to solve the 0 norm, and an updated iterative formula for the model parameters can be obtained:

$${y}^{k + 1} = ( {L}^{T} L + {λ}_{1} {φ}^{T} φ + {λ}_{2} {D}^{T} \cdot {( ( diag ( {Dy}^{k} ) + μ I ) )}^{- 2} D ) ∖ ( {L}^{T} x + {λ}_{1} {φ}^{T} {y}^{k} ) \qquad ( 12 )$$

in the formula, L=0.5·W·D represents the forward operator; y=In(z) represents the logarithm of the impedance parameters; W represents the wavelet matrix, X represents the seismic record, I is a unit matrix of Nₓ×Nₓ, and Nₓ is the length of the observed data; diag represents an operator for constructing a diagonal matrix; λ₁ and λ₂ represent the weights of the initial model priori information constraint term and the sparse constraint term, respectively; μ is a constant to ensure that the matrix is diagonally dominant.

Specifically, in step 170, uncertainty information of inversion results is calculated based on the Bayesian framework while calculating the optimal impedance parameter inversion result. Uncertainty of inversion results can be given while predicting inversion results based on the seismic inversion method based on joint constraint of a physical model and priori information to achieve quantitative reliability evaluation of inversion results:

$$Σ = {C}_{z} - ( {( {LC}_{z} )}^{T} / ( {LC}_{z} {L}^{T} + μ I ) ) \cdot {LC}_{z} \qquad ( 13 )$$

in the formula, C_{z} represents the model covariance matrix; L represents the forward operator; μ is a constant to ensure that the matrix is diagonally dominant; I is the unit matrix of Nₓ×Nₓ, and Nₓ is the length of the observed data.

A computer device, including a memory and a processor, where the memory is configured to store computer-executable instructions, and the processor is configured to execute the computer-executable instructions. When the computer-executable instructions are executed by the processor, the steps of the above method are implemented.

A computer-readable storage medium storing computer-executable instructions, where when the computer-executable instructions are executed by a processor, the steps of the above method are implemented.

The present disclosure has the following advantages:
1. In the present disclosure, impedance is estimated directly from seismic data, avoiding an cumulative error caused by trace integration and recursive inversion methods;
2. In the present disclosure, a physical model is introduced to ensure that prediction result meets the observed seismic data, and an initial model priori information constraint term is designed to improve the accuracy of inversion results while reducing the multi-solution of inversion results;
3. In the present disclosure, a sparse priori constraint term and a vertical constraint term are introduced, which can well highlight the boundary features of inversion results and ensure the vertical continuity of inversion results;
4. Uncertainty of inversion results is given while predicting inversion results based on the Bayesian framework, which can achieve the quantitative reliability evaluation of inversion results.

### BRIEF DESCRIPTION OF THE DRAWINGS

FIG. 1 is a flowchart of a seismic inversion method based on joint constraint of a physical model and priori information according to the present disclosure;

FIG. 2 is a diagram of input post-stack seismic data without noise and initial impedance parameter model according to the present disclosure;

FIG. 3 is a diagram of input post-stack seismic data with noise and initial impedance parameter model according to the present disclosure;

FIG. 4 is a diagram of impedance obtained by means of inversion with the seismic inversion method based on joint constraint of a physical model and priori information, as well as uncertainty information of the impedance according to the present disclosure without noise; and

FIG. 5 is a diagram of impedance obtained by means of inversion with the seismic inversion method based on joint constraint of a physical model and priori information, as well as uncertainty information of the impedance according to the present disclosure with noise.

### DETAILED DESCRIPTION

The present disclosure is further described below in conjunction with the accompanying drawings, but the scope of protection of the present disclosure is not limited to the following description.

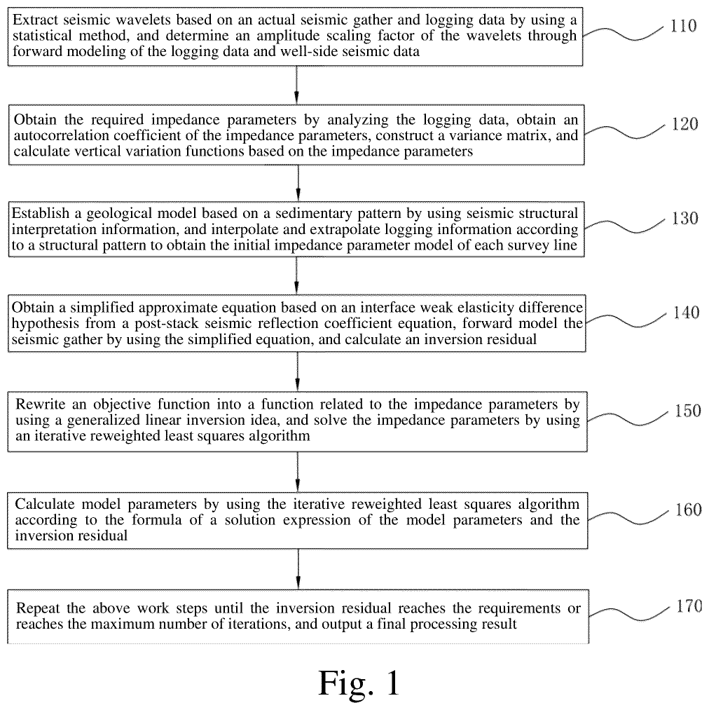

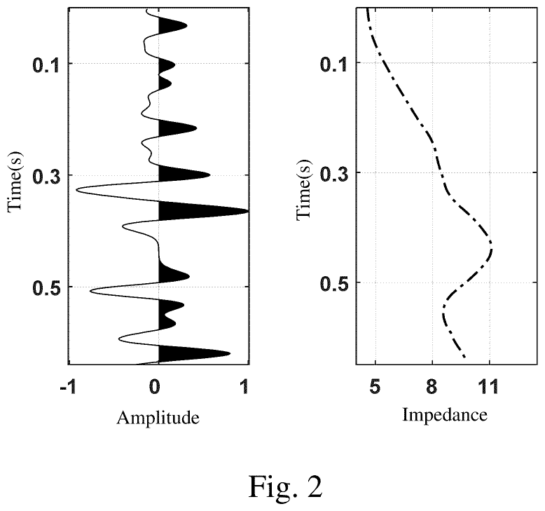

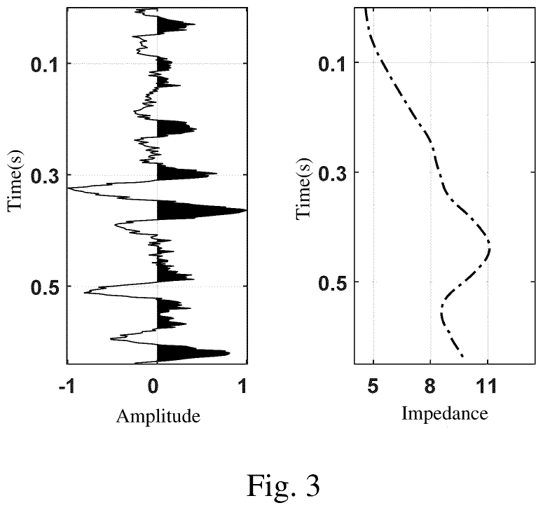

As shown in FIGS. 1 to 5, a seismic inversion method based on joint constraint of a physical model and priori information includes the following steps:

Step 110: Assume that seismic wavelets are known before inversion. Thus, it is necessary to extract the wavelets based on an actual seismic gather and logging data by using a statistical method. An actual seismic amplitude is often a relative value, and there is a certain numerical difference between the amplitude of seismic data forward modeled by a post-stack seismic reflection coefficient equation and the actual amplitude. A reflection coefficient is calculated by using the post-stack seismic reflection coefficient equation and taking the logging data as an input model:

$${r}_{i} = f ( m ) = \frac{{m}_{i + 1} - {m}_{i}}{{m}_{i + 1} + {m}_{i}} \qquad ( 1 )$$

In the formula, m represents logging impedance parameter data, and r represents the calculated reflection coefficient;

The reflection coefficient is then convolved with the extracted seismic wavelets to obtain a seismic gather which is compared with an actual well-side seismic gather, and an amplitude scaling factor is calculated and applied to the extracted seismic wavelets to achieve amplitude matching between a modeling record and an actual record:

$$x = w ⊗ r \qquad ( 2 )$$

In the formula, x represents a synthetic seismic record, ⊕ represents a convolution operator, and w represents the extracted wavelets.

Step 120: Extract impedance parameters and a mean value thereof based on all logging data in a work area, and statistically calculate a variance and a vertical variation function matrix of the impedance parameters. The required impedance parameters are obtained by analyzing the logging data, an autocorrelation coefficient of the impedance parameters is obtained, a variance matrix is constructed, and vertical variation functions are calculated based on the impedance parameters to form impedance parameter priori distribution functions that conform to the work area;

The calculation formula of the vertical variation functions is as follows:

$$υ ( h ) = \frac{1}{2 N} {\sum }_{i = 1}^{N} {[ z ( {x}_{i} ) - z ( {x}_{i} + h ) ]}^{2} \qquad ( 3 )$$

Where ν represents a variation function value calculated based on well data, h represents a hysteresis distance, N represents the length of the logging data, and z(xᵢ) represents the impedance parameter value at a location i.

Step 130: Establish an initial impedance parameter model in a time domain by using seismic data layer interpretation information and the logging data. A geological model is established based on a sedimentary pattern by using seismic structural interpretation information, and logging information is interpolated and extrapolated according to a structural pattern to obtain the initial impedance parameter model of each survey line. An impedance parameter model is established by using a spatial interpolation method, in which the data of each layer is interpolated first by using a scattered interpolation method to complete geological layer modeling, and then lateral interpolation of the impedance parameters is carried out according to geological layers to calculate the impedance parameter value at each point underground, so as to complete initial impedance parameter modeling.

Step 140: Derive a linear approximate equation based on an interface weak elasticity difference hypothesis from an accurate post-stack reflection coefficient equation:

$${r}_{i} = f ( m ) = \frac{{m}_{i + 1} - m}{{m}_{i + 1} + m} \approx 0.5 \times ( ln ( {m}_{i + 1} ) - ln ( {m}_{i} ) ) \qquad ( 4 )$$

In the formula, m represents the impedance parameter data, r represents the calculated reflection coefficient, and In represents the logarithm of the data;

Forward model the post-stack seismic gather based on the initial impedance parameter model in the time domain and a simplified equation. The initial impedance parameter model in the time domain is taken as input, a reflection coefficient vector is directly calculated by using the simplified equation, the seismic wavelets are convolved with the reflection coefficient to obtain the post-stack seismic gather, and the post-stack seismic gather is subtracted from an actual seismic gather to obtain the inversion residual:

$$x = w ⊗ r = 0.5 \cdot K \cdot D \cdot ln ( m ) \qquad ( 5 )$$

In the formula, K represents a wavelet matrix constructed based on w, D represents a difference operator, and m represents the impedance parameter data.

Step 150: Construct an inversion objective function in the sense of maximum a posteriori probability based on the Bayesian principle, as well as the introduction of a sparse priori constraint term and an initial model priori information constraint term, and solve the inversion objective function by using a generalized linear inversion idea to obtain a solution expression for the impedance parameters. The inversion result is constrained by using the initial model, and it is assumed that seismic data noise obeys Gaussian distribution. The initial model priori information constraint term obeys the Gaussian distribution and the model obeys sparse distribution, then an inversion likelihood function and priori probability distribution satisfy the Gaussian distribution and the joint distribution of Gaussian and sparse, respectively. The inversion likelihood function and the priori distribution function are integrated according to the Bayesian principle to obtain a posteriori probability distribution function, the inversion objective function is determined according to the posteriori probability, and the objective function is derived from the model parameters to obtain an iterative solution formula.

Assuming that the impedance model parameters are z^{T}=(z₁, z₂, . . . , zₙ)^{T} and the observed seismic data are x^{T}=(x₁, x₂, . . . , xₙ)^{T}, it can be learned from the Bayesian theory that, in a case where the post-stack seismic data are known, the problem of inverting impedance parameters of an underground medium can be reduced to solving a posteriori probability function:

$$P ( z \vert x ) = \frac{P ( x \vert z ) P ( z )}{P ( x )} \qquad ( 6 )$$

Where P(x)=∫p(x|z)p(z)dz is a normalization factor that can be regarded as a constant, P(x|z) is a likelihood function, and P(z) is the priori probability distribution. It is assumed that the likelihood function satisfies the Gaussian distribution:

$$P ( x \vert z ) = {( {( 2 π )}^{{N}_{x}} \vert {C}_{X} \vert )}^{- 1 / 2} exp ( - \frac{1}{2} {( x - Γ ( z ) )}^{T} {C}_{X}^{- 1} ( x - Γ ( z ) ) ) \qquad ( 7 )$$

In the above formula, Γ is a forward operator, C_{X} is a noise covariance matrix, and Nₓ is the length of the observed data. A normalization constant is removed based on the Bayesian theory in combination with a priori model, and the posteriori probability distribution of post-stack seismic data inversion can be expressed as:

$$\begin{matrix}P ( z \vert x ) ∝ P ( x \vert z ) P ( z ) \\ ∝ exp ( - \frac{1}{2} {( x - Γ ( z ) )}^{T} {C}_{X}^{- 1} ( x - Γ ( z ) ) ) \\ * exp ( - \frac{1}{2} {( {z}_{0} - φ z )}^{T} {C}_{𝓏}^{- 1} ( {z}_{0} - φ z ) ) \\ * exp ( - Φ ( z ) )\end{matrix} \qquad ( 8 )$$

In the expression, Γ is the forward operator, Φ(z) represents the sparse constraint term, z₀ represents the initial impedance parameter, q represents a smoothing operator, C_{X} is the noise covariance matrix, and C_{z} represents a model covariance matrix that can be obtained by Kronecker product of the variance α counted by the logging data and the variation function matrix ν. The specific expressions of Φ(z) and φ are as follows:

$$Φ ( z ) = {‖ Dz ‖}_{0} \qquad ( 9 )$$

In the expression, D represents the difference operator. If three-point smoothing is used, the expression of φ can be written as:

$$φ = {[ \begin{matrix}1 / 3 & 1 / 3 & 1 / 3 & & & & & & & \\ & 1 / 3 & 1 / 3 & 1 / 3 & & & & & & \\ & & 1 / 3 & 1 / 3 & 1 / 3 & & & & & \\ & & & & & & & & & \\ & & & & & ⋱ & & & & \\ & & & & & & ⋱ & & & \\ & & & & & & & & & \\ & & & & & 1 / 3 & 1 / 3 & 1 / 3 & & \\ & & & & & & 1 / 3 & 1 / 3 & 1 / 3 & \\ & & & & & & & 1 / 3 & 1 / 3 & 1 / 3\end{matrix} ]}_{n \times n} \qquad ( 10 )$$

The expression of φ can be modified according to expression (10) according to different specific smoothing levels.

The optimal solution can be obtained by solving the maximum value of expression (8), which is equivalent to solving the solution corresponding to the minimum value of the objective function of the following formula:

$$J = \frac{1}{2} {( x - Γ ( z ) )}^{T} {C}_{x}^{- 1} ( x - Γ ( z ) ) + \frac{1}{2} {( {z}_{0} - φ z )}^{T} {C}_{z}^{- 1} ( {z}_{0} - φz ) + {‖ Dz ‖}_{0} \qquad ( 11 )$$

The objective function obtained above is derived with respect to the impedance parameter z and the derivative is set equal to zero. Since the 0 norm is not derivable, the iterative reweighted least squares algorithm is used to solve the 0 norm, and an updated iterative formula for the model parameters can be obtained:

$${y}^{k + 1} = ( {L}^{T} L + {λ}_{1} {φ}^{T} φ + {λ}_{2} {D}^{T} \cdot {( ( diag ( {Dy}^{k} ) + μ I ) )}^{- 2} D ) \text{\textbackslash (} {L}^{T} x + {λ}_{1} {φ}^{T} {y}^{k} ) \qquad ( 12 )$$

In the formula, L=0.5·W·D represents the forward operator; y=In(z) represents the logarithm of the impedance parameters; W represents the wavelet matrix, X represents the seismic record, I is a unit matrix of Nₓ×Nₓ, and Nₓ is the length of the observed data; diag represents an operator for constructing a diagonal matrix; λ₁ and λ₂ represent the weights of the initial model priori information constraint term and the sparse constraint term, respectively; μ is a constant to ensure that the matrix is diagonally dominant.

Step 160: Calculate model parameters by using an iterative reweighted least squares algorithm according to the formula of a solution expression of the model parameters and the inversion residual;

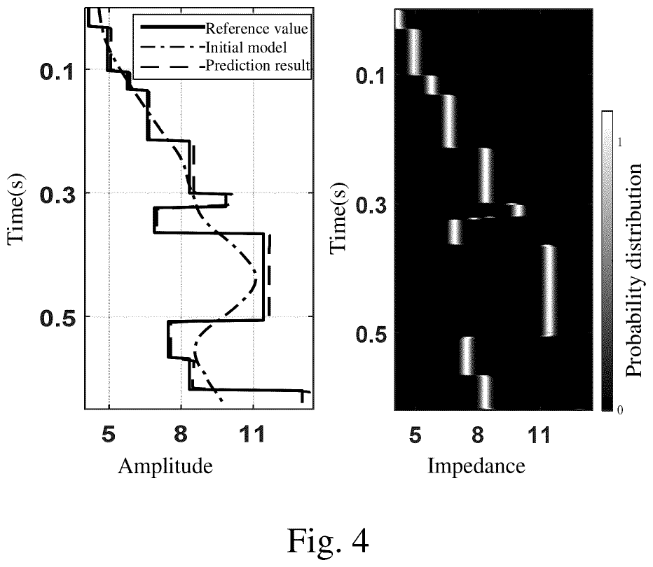

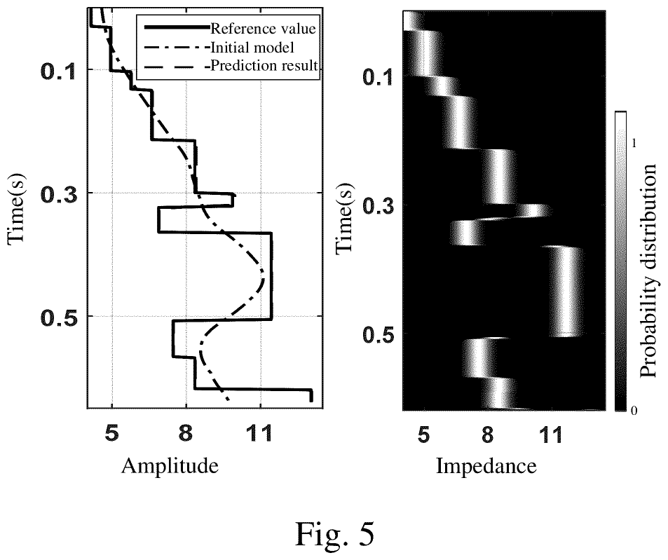

Step 170: Repeat the iterations of the steps 140, 150, and 160, and control the maximum number of iterations by means of the inversion residual to obtain an optimal impedance parameter inversion result. FIGS. 4 and 5 show the impedance parameters inverted based on the seismic inversion method based on joint constraint of a physical model and priori information in the embodiments of the present disclosure. In the figures, the vertical axis represents time in seconds, and the horizontal axis represents impedance (unit: g/cm³·km/s). By means of the present disclosure, impedance parameter information can be predicted with high accuracy. FIG. 5 shows an inversion result when random noise with a signal-to-noise ratio of 4 is added. The introduction of the priori model plays a key role in maintaining the stability of the inversion process and improving the accuracy of inversion results. Based on the Bayesian framework, uncertainty information of inversion results can be calculated (Formula 13) while calculating inversion results, and the uncertainty is as shown in the colors of the bottom figure on the right of FIG. 4 and the right of FIG. 5. By means of the present disclosure, uncertainty of inversion results can be given while predicting inversion results to achieve quantitative reliability evaluation of inversion results.

$$\sum = {C}_{z} - ( {( {LC}_{z} )}^{T} / ( {LC}_{z} {L}^{T} + μ I ) ) \cdot {LC}_{z} \qquad ( 13 )$$

In the formula, C_{z} represents the model covariance matrix; L represents the forward operator; μ is a constant to ensure that the matrix is diagonally dominant; I is the unit matrix of Nₓ×Nₓ, and Nₓ is the length of the observed data.

A computer device includes a memory and a processor. The memory is configured to store computer-executable instructions, and the processor is configured to execute the computer-executable instructions. When the computer-executable instructions are executed by the processor, the steps of the above method are implemented.

A computer-readable storage medium stores computer-executable instructions. When the computer-executable instructions are executed by a processor, the steps of the above method are implemented.

By means of the above method, stable and high-precision prediction of impedance parameters can be achieved.

1. A seismic inversion method based on joint constraint of a physical model and priori information, comprising the following steps:
step 110: extracting wavelets by using actual seismic data of an underground geological structure, forward modeling a seismic gather based on logging data and a post-stack seismic reflection coefficient equation, and determining an amplitude scaling factor in combination with actual well-side seismic data;
step 120: extracting impedance parameters and a mean value thereof based on all logging data in a work area, and statistically calculating a variance and a vertical variation function matrix of the impedance parameters;
step 130: establishing an initial impedance parameter model in a time domain by using seismic data layer interpretation information and the logging data;
step 140: deriving a linear approximate equation based on an interface weak elasticity difference hypothesis by using an accurate post-stack reflection coefficient equation, forward modeling the post-stack seismic gather based on the initial impedance parameter model in the time domain and a simplified equation, and directly calculating an inversion residual from a forward modeling record and an actual record;
step 150: constructing an inversion objective function in the sense of maximum a posteriori probability based on the Bayesian principle, as well as the introduction of a sparse priori constraint term and an initial model priori information constraint term, and solving the inversion objective function by using a generalized linear inversion idea to obtain a solution expression for the impedance parameters;
step 160: calculating model parameters by using an iterative reweighted least squares algorithm according to the formula of a solution expression of the model parameters and the inversion residual;
step 170: repeating the iterations of the steps 140, 150, and 160, controlling the maximum number of iterations by means of the inversion residual, and outputting an optimal impedance parameter inversion result; and
determining whether oil and gas reservoirs exist within the underground geological structure based on the optimal impedance parameter inversion result.

2. The seismic inversion method based on joint constraint of a physical model and priori information according to claim 1, wherein in step 170, uncertainty information of inversion results is calculated based on a Bayesian framework while calculating the optimal impedance parameter inversion result to achieve quantitative reliability evaluation of inversion results:
$$\sum = {C}_{z} - ( {( {LC}_{z} )}^{T} / ( {LC}_{z} {L}^{T} + μ I ) ) \cdot {LC}_{z} \qquad ( 13 )$$
In the formula, C_{z} represents the model covariance matrix; L represents the forward operator; μ is a constant to ensure that the matrix is diagonally dominant; I is the unit matrix of Nₓ×Nₓ, and Nₓ is the length of the observed data.

3. The seismic inversion method based on joint constraint of a physical model and priori information according to claim 1, wherein in step 110, a reflection coefficient is calculated by using the post-stack seismic reflection coefficient equation and taking the logging data as an input model:
$${r}_{i} = f ( m ) = \frac{{m}_{i + 1} - {m}_{i}}{{m}_{i + 1} + {m}_{i}} \qquad ( 1 )$$
in the formula, m represents logging impedance parameter data, and r represents the calculated reflection coefficient;
the reflection coefficient is then convolved with the extracted seismic wavelets to obtain a seismic gather which is compared with an actual well-side seismic gather, and the amplitude scaling factor is calculated and applied to the extracted seismic wavelets to achieve amplitude matching between a modeling record and an actual record:
$$x = w ⊗ r \qquad ( 2 )$$
in the formula, x represents a synthetic seismic record, ⊕ represents a convolution operator, and w represents the extracted wavelets.

4. The seismic inversion method based on joint constraint of a physical model and priori information according to claim 3, wherein in step 120, the required impedance parameters are obtained by analyzing the logging data, an autocorrelation coefficient of the impedance parameters is obtained, a variance matrix is constructed, and the vertical variation function matrix is calculated based on the impedance parameters to form impedance parameter priori distribution functions that conform to the work area;
the calculation formula of vertical variation functions is as follows:
$$υ ( h ) = \frac{1}{2 N} {\sum }_{i = 1}^{N} {[ z ( {x}_{i} ) - z ( {x}_{i} + h ) ]}^{2} \qquad ( 3 )$$
where ν represents a variation function value calculated based on well data, h represents a hysteresis distance, N represents the length of the logging data, and z(xi) represents the impedance parameter value at a location i.

5. The seismic inversion method based on joint constraint of a physical model and priori information according to claim 4, wherein in step 130, a geological model is established based on a sedimentary pattern by using seismic structural interpretation information, and logging information is interpolated and extrapolated according to a structural pattern to obtain the initial impedance parameter model of each survey line.

6. The seismic inversion method based on joint constraint of a physical model and priori information according to claim 5, wherein in step 130, an impedance parameter model is established by using a spatial interpolation method, in which the data of each layer is interpolated first by using a scattered interpolation method to complete geological layer modeling, and then lateral interpolation of the impedance parameters is carried out according to geological layers to calculate the impedance parameter value at each point underground, so as to complete initial impedance parameter modeling.

7. The seismic inversion method based on joint constraint of a physical model and priori information according to claim 6, wherein in step 140, the linear approximate equation is derived based on the weak elasticity difference hypothesis:
$${r}_{i} = f ( m ) = \frac{{m}_{i + 1} - {m}_{i}}{{m}_{i + 1} + {m}_{i}} \approx 0.5 \times ( ln ( {m}_{i + 1} ) - ln ( {m}_{i} ) ) \qquad ( 4 )$$
in the formula, m represents the impedance parameter data, r represents the calculated reflection coefficient, and In represents the logarithm of the data;
the initial impedance parameter model in the time domain is then taken as input, a reflection coefficient vector is directly calculated by using the simplified equation, the seismic wavelets are convolved with the reflection coefficient to obtain the post-stack seismic gather, and the post-stack seismic gather is subtracted from an actual seismic gather to obtain the inversion residual:
$$x = w ⊗ r = 0.5 \cdot K \cdot D \cdot ln ( m ) \qquad ( 5 )$$
in the formula, K represents a wavelet matrix constructed based on w, D represents a difference operator, and m represents the impedance parameter data.

8. The seismic inversion method based on joint constraint of a physical model and priori information according to claim 7, wherein in step 150, the inversion result is constrained by using the initial model, and it is assumed that seismic data noise obeys Gaussian distribution; the initial model priori information constraint term obeys the Gaussian distribution and the model obeys sparse distribution, then an inversion likelihood function and priori probability distribution satisfy the Gaussian distribution and the joint distribution of Gaussian and sparse, respectively; the inversion likelihood function and the priori distribution function are integrated according to the Bayesian principle to obtain a posteriori probability distribution function, the inversion objective function is determined according to the posteriori probability distribution function, and the objective function is derived from the model parameters to obtain an iterative solution formula:
$${y}^{k + 1} = ( {L}^{T} L + {λ}_{1} {φ}^{T} φ + {λ}_{2} {D}^{T} \cdot {( ( diag ( {Dy}^{k} ) + μ I ) )}^{- 2} D ) \text{\textbackslash (} {L}^{T} x + {λ}_{1} {φ}^{T} {y}^{k} ) \qquad ( 12 )$$
In the formula, L=0.5·W·D represents the forward operator; y=In(z) represents the logarithm of the impedance parameters; W represents the wavelet matrix, X represents the seismic record, I is a unit matrix of Nₓ×Nₓ, and Nₓ is the length of the observed data; diag represents an operator for constructing a diagonal matrix; λ₁ and λ₂ represent the weights of the initial model priori information constraint term and the sparse constraint term, respectively; μ is a constant to ensure that the matrix is diagonally dominant.

9. A computer device, comprising a memory and a processor, wherein the memory is configured to store computer-executable instructions, and the processor is configured to execute the computer-executable instructions; when the computer-executable instructions are executed by the processor, the steps of the method as claimed in claim 1 are implemented.

10. A computer-readable storage medium storing computer-executable instructions, wherein when the computer-executable instructions are executed by a processor, the steps of the method as claimed in claim 1 are implemented.
